(19) United States
(12) Patent Application Publication
(10) Pub. No.: US 2010/0020300 A1
(43) Pub. Date: Jan. 28, 2010

(54) MEASUREMENT APPARATUS AND METHOD

(75) Inventors: Willem Jan Bouman, Moergestel (NL); Heine Melle Mulder, Veldoven (NL); Wilfred Edward Endendijk, Steensel (NL); Rob Otte, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/506,481

(22) Filed: Jul. 21, 2009

Related U.S. Application Data
(60) Provisional application No. 61/129,873, filed on Jul. 25, 2008.

(51) Int. Cl. G03B 27/54

(52) U.S. Cl. 355/67

(57) ABSTRACT

According to an aspect of the present invention, a method of controlling a measurement apparatus for determining a property of an individually controllable element of an array of individually controllable elements, the array of individually controllable elements being capable of controlling a distribution of a beam of radiation, is disclosed. The method includes, for a sequence of a plurality of individually controllable elements: directing a measurement beam of radiation at an individually controllable element of the plurality of individually controllable elements; and detecting the measurement beam once it has been re-directed by the individually controllable element, wherein the sequence in which the method is undertaken for the plurality of individually controllable elements is related to the orientation of the plurality of individually controllable elements when the plurality of individually controllable elements are oriented to control a distribution of a beam of radiation.

This application claims priority and benefit under 35 U.S.C. §119(e) to U.S. Provisional Patent Application No. 61/129,873, entitled “Measurement Apparatus and Method”, filed on Jul. 25, 2008. The content of that application is incorporated herein in its entirety by reference.

### FIELD

The present invention relates to a measurement apparatus and method. In particular, although not exclusively, the present invention relates to a measurement apparatus and method for use in lithography, for example in connection with an illumination system of a lithographic apparatus.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

A lithographic apparatus typically comprises an illuminator (sometimes referred to as an illumination system) configured to provide a conditioned illumination beam of radiation to, for example, a patterning device of the lithographic apparatus. It is sometimes advantageous to provide an illumination beam with a particular angular intensity distribution, sometimes referred to in the art as a particular ‘illumination mode’. In some lithographic apparatuses, one or more diffractive optical elements may be provided within the illuminator in order control the distribution of the illumination beam and to create the desired illumination mode. Alternatively or additionally, an array of individually controllable elements (such as a programmable mirror array or array of moveable mirrors) may be provided in the illuminator to selectively reflect portions of the illumination beam in order to create, or assist in creation of, a desired illumination mode. An advantage of using an array of individually controllable elements is that elements of the array can be readily changed from one configuration to another, meaning that the illumination mode can also be so readily changed from one illumination mode to another. At least in some respects, the use of an array of individually controllable elements is therefore advantageous.

### SUMMARY

Although the use of an array of individually controllable elements in the illuminator of a lithographic apparatus may, at least in some respects, be advantageous, there may nevertheless be a disadvantage associated with the use of an array of individually controllable elements. A disadvantage may be a desire to quickly address (and, for example, actuate) large numbers of elements of the array in a short period of time. To quickly address and/or actuate a large number of elements in a short period of time means there is a large data flow to the elements, or at least control apparatus associated with the elements or groups of elements. Such a large flow of data often serves as a restriction for the detection of a property (i.e., a single or multiple properties) of elements of the array, or the speed of actuation of elements of the array.

It is therefore desirable, for example, to provide a measurement and control apparatus, and/or an associated method, for solving one or more of the problems referred to above and/or one or more problems not referenced herein.

According to an aspect of the present invention, there is provided a method of controlling a measurement apparatus for determining a property of an individually controllable element of an array of individually controllable elements, the array of individually controllable elements being capable of controlling a distribution of a beam of radiation, the method comprising, for a sequence of a plurality of individually controllable elements: directing a measurement beam of radiation at an individually controllable element of the plurality of individually controllable elements; and detecting the measurement beam once it has been re-directed by the individually controllable element, wherein the sequence in which the method is undertaken for the plurality of individually controllable elements is related to the orientation of the plurality of individually controllable elements when the plurality of individually controllable elements are oriented to control a distribution of a beam of radiation.

The position at which the re-directed measurement beam is detected may be indicative of a property of the individually controllable element. The sequence in which the method is undertaken for the plurality of individually controllable elements may be related to the orientation of the plurality of individually controllable elements when the plurality of individually controllable elements are oriented to control an angular and/or intensity distribution of a beam of radiation. The orientation of the plurality of individually controllable elements may correspond to a distribution of the radiation beam in an output plane. The orientation of the plurality of individually controllable elements may correspond to an expected distribution of the position of detection of the measurement beams of radiation for the plurality of elements in sequence.

The sequence may be related to a distribution of different parts of the radiation beam in an output plane that is created by the radiation beam being re-directed by the plurality of individually controllable elements. The sequence may be related to individually controllable elements which re-direct parts of the radiation beam to positions that are adjacent to one another in the output plane. The sequence may be such that a path around the positions of the plurality of re-directed parts of the radiation beam in the output plane is the shortest. The parts of the radiation beam may be formed by different portions of the radiation beam being re-directed by different individually controllable elements.

The sequence may be related to an expected position of detection of the measurement beams of radiation on the surface of a detector for the plurality of elements in sequence. The surface may be a single continuous surface or may be formed by a plurality of independent surfaces. For example, the surface may comprise a plurality of photodiode detection surfaces, or a CCD. The sequence may be related to elements which re-direct the measurement beam of radiation to detection positions that are adjacent to one another. The sequence may be such that a path around the detection positions is the shortest.

According to an aspect of the present invention, there is provided a method of controlling an array of individually controllable elements, the array of individually controllable elements being capable of controlling a distribution of a beam of radiation, the array of individually controllable elements comprising: a first plurality of individually controllable elements controlled by a first control apparatus; and a second plurality of individually controllable elements controlled by a second control apparatus, the method comprising: controlling the first control apparatus and the second control apparatus such that consecutive actuations of the individually controllable elements of the array of individually controllable elements are undertaken by a different one of the first control apparatus and second control apparatus.

The array of individually controllable elements may be arranged to re-direct different parts of the radiation beam to different positions in an output plane. The method may further comprise: controlling the array of individually controllable elements such that re-directed parts of the radiation beam which are re-directed to positions which are adjacent to one another in the output plane are re-directed by elements which are controlled by a different one of the first control apparatus and second control apparatus.

The method may be undertaken for a sequence of measurements of the individually controllable elements of the array of individually controllable elements, and also for a sequence of actuations of the individually controllable elements of the array of individually controllable elements, there being a delay between the measurement and actuation of an individually controllable element.

According to an aspect of the present invention, there is provided a method of controlling a measurement apparatus for determining a property of individually controllable elements of an array of individually controllable elements, the array of individually controllable elements being capable of controlling a distribution of a beam of radiation, the method comprising: directing a measurement beam of radiation at a first individually controllable element; and detecting the measurement beam once it has been re-directed by the first individually controllable element, wherein a property of a second individually controllable element of the array of individually controllable elements is determined from information at least indicative of the property of the first individually controllable element.

The position at which the re-directed measurement beam is detected may be indicative of a property of the first individually controllable element. A property of a plurality of second individually controllable elements of the array of individually controllable elements may be determined from information at least indicative of the property of the first individually controllable element.

Elements for which direct measurements have been undertaken may be described as ‘first’ elements, or sets of first elements, and elements for which direct measurements have not been undertaken may be described as ‘second’ elements, or sets of second elements.

The second individually controllable element may be located adjacent to the first individually controllable element. The second individually controllable element may be located in the array at a position that is next to a position of the first individually controllable element.

The method may be undertaken for a plurality of first individually controllable elements and a plurality of second individually controllable elements.

The property of the second individually controllable element may be determined using a property of at least two first individually controllable elements.

The method may be undertaken for a first set of first individually controllable elements and a first set of second individually controllable elements, and then the method is undertaken for a second set of first individually controllable elements and a second set of second individually controllable elements.

The individually controllable elements of the first set of first individually controllable elements may be different to the individually controllable elements of the second set of first individually controllable elements. The individually controllable elements of the first set of first individually controllable elements may be located in positions in the array of individually controllable elements which are adjacent to the positions of the individually controllable elements of the second set of first individually controllable elements.

The property of the second individually controllable element may be determined from an extrapolation of the property of the first individually controllable element, from a projection of the property of the first individually controllable element, from an estimate based on the property of the first individually controllable element, or from a model or simulation based on the property of the first individually controllable element.

According to an aspect of the present invention, one or more of the above methods may be undertaken for an array of individually controllable elements of a lithographic apparatus. The method(s) may be undertaken for an array of individually controllable elements of an illuminator of a lithographic apparatus.

According to an aspect of the present invention, there is provided a measurement arrangement, comprising: a radiation source configured to provide a measurement beam of radiation, the measurement beam of radiation being arranged to be directed at an individually controllable element of an array of individually controllable elements, the array of individually controllable elements being capable of controlling a distribution of a beam of radiation, and the individually controllable element being arranged to re-direct the measurement beam of radiation; a detector arranged to receive the re-directed measurement beam; and a controller configured to control the radiation source and/or the detector, the controller being configured such that, for a sequence of a plurality of individually controllable elements: a measurement beam of radiation is arranged to be directed at an individually controllable element of the plurality of individually controllable elements, and the measurement beam is arranged to be detected once it has been re-directed by the individually controllable element, wherein the sequence is related to the orientation of the plurality of individually controllable elements when the plurality of individually controllable elements are oriented to control a distribution of a beam of radiation.

According to an aspect of the present invention, there is provided an arrangement for controlling a distribution of a beam of radiation, the arrangement comprising: an array of individually controllable elements, the array of individually controllable elements being capable of controlling a distribution of a beam of radiation; a first control apparatus configured to control a first plurality of individually controllable elements of the array of individually controllable elements; a second control apparatus configured to control a second plurality of individually controllable elements of the array of individually controllable elements; and a controller arranged to control the first control apparatus and the second control apparatus such that consecutive actuations of the individually controllable elements of the array of individually controllable elements are undertaken by a different one of the first control apparatus and second control apparatus.

According to an aspect of the present invention, there is provided a measurement arrangement, comprising: a radiation source configured to provide a measurement beam of radiation, the measurement beam of radiation being arranged to be directed at a first individually controllable element of an array of individually controllable elements, the array of individually controllable elements being capable of controlling a distribution of a beam of radiation, and the individually controllable element being arranged to re-direct the measurement beam of radiation; a detector arranged to receive the re-directed measurement beam; and a determination arrangement configured to determine a property of a second individually controllable element from information at least indicative of the property of the first individually controllable element.

According to an aspect of the present invention, the array of individually controllable elements may be an array of individually controllable elements of a lithographic apparatus. The array of individually controllable elements may be an array of individually controllable elements of an illuminator of a lithographic apparatus.

According to an aspect of the present invention, there is provided a lithographic apparatus provided with the above arrangements.

According to any aspect of the present invention, a property of an individually controllable element that may be measured or determined may relate to the orientation and/or the degree of elevation (e.g. relative to a neutral or equilibrium position) of the individually controllable element. The property of an individually controllable element that may be measured or determined may be the degree of tilt of the element in one or more dimensions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a schematic depiction of a one-dimensional array of individually controllable elements provided in an illuminator, and an apparatus to determine a property of those elements;

FIG. 3 is a schematic depiction of part of the array of individually controllable elements shown in FIG. 2;

FIG. 4 is a schematic depiction of the change in the position of beams of radiation reflected from elements of the array of individually controllable elements shown in FIG. 3;

FIG. 5 schematically depicts an improved sequence of detecting a property of elements of the array of individually controllable elements shown in FIG. 3, in accordance with an embodiment of the present invention;

FIG. 6 is a schematic depiction of a two-dimensional array of individually controllable elements provided in an illuminator;

FIG. 7 is a schematic depiction of the change in the position of beams of radiation reflected from elements of the array of individually controllable elements shown in FIG. 6;

FIG. 8 schematically depicts an improved sequence of detecting a property of elements of the array of individually controllable elements shown in FIG. 6, in accordance with an embodiment of the present invention;

FIG. 9 is a schematic depiction of another two-dimensional array of individually controllable elements provided in an illuminator;

FIG. 10 schematically depicts an order in which elements of the array of individually controllable elements shown in FIG. 9 may be addressed for actuation;

FIG. 11 schematically depicts an improved order in which elements of the array of individually controllable elements shown in FIG. 9 may be addressed for actuation, in accordance with an embodiment of the present invention;

FIG. 12 schematically depicts an order in which elements of the array of individually controllable elements shown in FIG. 9 may be addressed for actuation, in accordance with an embodiment of the present invention;

FIG. 13 is a schematic depiction of the two-dimensional array of individually controllable elements provided in an illuminator, as shown in FIG. 9, indicating two elements controlled by different control apparatus; and

FIG. 14 is a schematic depiction of a part of another two-dimensional array of individually controllable elements provided in an illuminator.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm).

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

The lithographic apparatus may also be of a type wherein the substrate is immersed in a liquid having a relatively high refractive index, e.g. water, so as to fill a space between the final element of the projection system and the substrate. Immersion techniques are well known in the art for increasing the numerical aperture of projection systems.

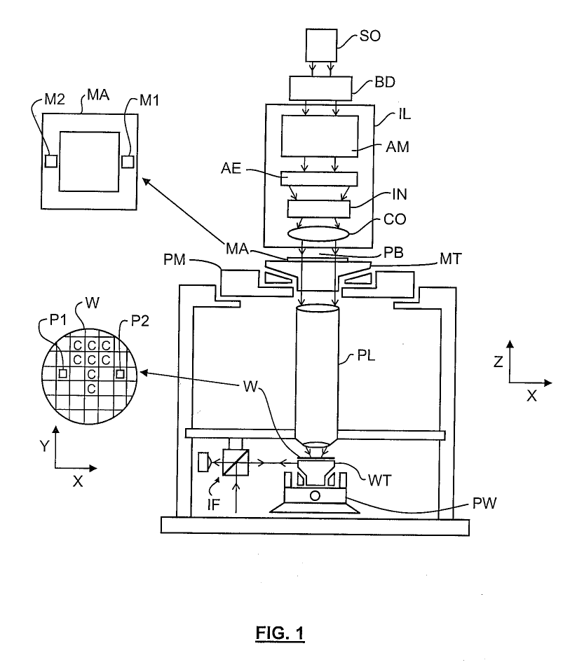

FIG. 1 schematically depicts a lithographic apparatus according to a particular embodiment of the invention. The apparatus comprises:

an illumination system (illuminator) IL to condition a beam PB of radiation (e.g. UV, or EUV or beyond EUV radiation);

a support structure (e.g. a support structure) MT to support a patterning device (e.g. a mask) MA and connected to first positioning device PM to accurately position the patterning device with respect to item PL;

a substrate table (e.g. a wafer table) WT for holding a substrate (e.g. a resist-coated wafer) W and connected to second positioning device PW to accurately position the substrate with respect to item PL; and

a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjuster AM configured to adjust the angular intensity distribution of the beam. Generally, at least the outer and/or inner radial extent (commonly referred to as σ-outer and σ-inner, respectively) of the intensity distribution in an output plane of the illuminator can be adjusted. The illuminator IL also comprises an array of individually controllable elements AE (e.g. a programmable mirror array or an array of mirrors that can be moved into position) that are used to control a distribution (e.g. angular and/or intensity distribution) of the beam, for example to create different illumination modes (as is known in the art). In addition, the illuminator IL generally comprises various other components, such as an integrator IN and a condenser CO. The illuminator provides a conditioned beam of radiation PB, having a desired uniformity and intensity distribution in its cross-section. The order of components in the illuminator IL may be different than that shown in the Figure. For example, in some embodiments, the adjuster AM may be the array of individually controllable elements.

The illumination system may also encompass various types of optical components, including refractive, reflective, and catadioptric optical components for directing, shaping, or controlling the beam of radiation, and such components may also be referred to below, collectively or singularly, as a “lens”.

The radiation beam PB is incident on the patterning device (e.g. mask) MA, which is held on the support structure MT. Having traversed the patterning device MA, the beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The support structure MT holds the patterning device. It holds the patterning device in a way depending on the orientation of the patterning device, the design of the lithographic apparatus, and other conditions, such as for example whether or not the patterning device is held in a vacuum environment. The support structure MT can use mechanical clamping, vacuum, or other clamping techniques, for example electrostatic clamping under vacuum conditions. The support structure MT may be a frame or a table, for example, which may be fixed or movable as required and which may ensure that the patterning device is at a desired position, for example with respect to the projection system.

The depicted apparatus can be used in the following preferred modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As mentioned above, a lithographic apparatus may include an array of individually controllable elements configured to control a distribution (e.g. the angular and/or intensity distribution) of a radiation beam passing through the illuminator. In such a lithographic apparatus, an incoming radiation beam having a first cross-sectional intensity distribution is incident onto the array of individually controllable elements. The array of individually controllable elements reflects the radiation beam, wherein the first cross-sectional distribution is spatially redistributed at an output plane into a second spatial intensity distribution. The output plane may be a pupil plane of the illuminator. In this embodiment, the array of individually controllable elements may be used for setting an illumination mode. Alternatively, the output plane may be a field plane of the illuminator. In this embodiment, the array of individually controllable elements may be used for improving a uniformity distribution of the radiation beam in said field plane.

An example of such a lithographic apparatus which includes an array of individually controllable elements in the illuminator is shown in, for example, United States patent application publication no. US 2008/0079930. US 2008/0079930 describes, for example, a mirror array which may be used to create an illumination mode in a radiation beam by selectively reflecting different parts of the radiation beam in different directions. In other words, the mirror array is used to control the angular intensity distribution of the radiation beam. US 2008/0079930 also discloses a measurement apparatus configured to obtain information at least indicative of one or more elements of the array of individually controllable elements (for example, mirrors) of the array. The information may include, for example, the degree of tilt of an element of the array. The degree of tilt may change over time, for instance due to heating of the array, charge build up within the array or general degradation of the array. The degree of tilt may also change due to mechanically and/or acoustically induced vibrations, and/or electrostatic interactions between adjacent elements of the array.

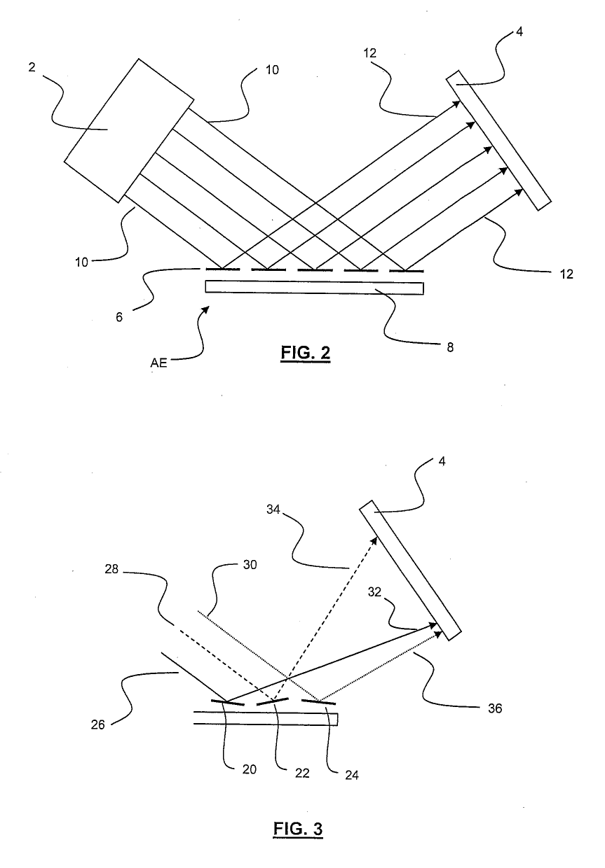

FIG. 2 schematically depicts an example of a one-dimensional array of individually controllable elements AE. FIG. 2 also schematically depicts an example of the measurement apparatus referred to above, in the form of a radiation emitter 2 and a radiation detector 4. The array of individually controllable elements comprises elements 6 (e.g. mirrors) which are supported by a support structure 8. The elements 6 are moveable relative to the support structure 8 to selectively reflect different parts of an incident radiation beam in different directions.

The radiation emitter 2 is arranged to provide a plurality of individual and discrete measurement radiation beams 10 (or, in other words, measurement beams of radiation). The measurement radiation beams 10 may be generated by individual light emitted diodes (LEDs) or lasers, or the like. The number of measurement radiation beams 10 that the radiation emitter 2 can provide is at least equal to the number of elements 6 provided in the array of individually controllable elements AE. This is so that radiation emitter 2 can direct a measurement beam of radiation 10 towards each of the elements 6 in order to obtain information about each of the elements 6. Information for a given element 6 may be obtained by detecting the measurement radiation beam 10 after it has been reflected off the element 6 (i.e. to provide a reflected measurement beam 12) which may be detected by the radiation detector 4. The radiation detector 4 may be provided with, for example, an array of detection elements, or may be provided with a single detection surface. A property of the elements 6 may be determined, for example, by change in the detected position of the reflected measurement beam 12. For instance, if in two successive actuations of a given element 6 in which the element is driven with the same driving voltage, a change in the angle (or in other words, the degree or extent) of the tilt of the element 6 associated with the same driving voltage may be determined by changes in the position of the reflected measurement beam 12. In other words, a change in the detected position of the reflected measurement beam may be used to provide information at least indicative of a property (in this case, a change in tilt) of an element. As mentioned above, changes in the tilt of the element for a given driving voltage may, for example, be associated with charge build up, heating of the array, or degradation of the array.

When the array of individually controllable elements AE are being used to control the distribution of a beam of radiation, information regarding, for example, the degree of tilt of the elements is not obtained using the measurement apparatus. Instead, information regarding, for example, the degree of tilt of the elements may be obtained before and/or after the array of individually controllable elements are going to be, or have been, used to control the distribution of a beam of radiation. For instance, in one example, the measurement apparatus may be used to determine the degree of tilt of all elements 6 of the array of individually controllable elements AE before the array of individually controllable elements AE is used to control distribution of a beam of radiation. By doing this, any changes (for example, drift) in the degree of the element 6 from a desired degree of tilt may be corrected for before the distribution of the radiation beam is controlled. Alternatively, the tilt of each element may be determined and corrected for in turn, rather than for the array as a whole. In another example, the degree of tilt of the elements, for example, may be determined when the array of individually controllable elements AE are being used to control the distribution of a beam of radiation.

FIG. 2 shows a plurality of measurement beams of radiation 10 incident upon the array of individually controllable elements AE simultaneously, and the reflected measurement beams of radiation beams 12 detected simultaneously. In practice this does not happen, since it would be difficult or impossible for the radiation detector 4 to be able to determine the element 6 from which a given reflected measurement beam 12 was reflected. FIG. 2 is therefore given as an explanatory aid to illustrate how a single measurement beam 10 is used to determine a property of a single element 6. In reality, a single different measurement radiation beam 10 is, in sequence, directed to a single different element 6 in sequence so that a property of each element 6 may be determined. This process is undertaken in sequence for all elements 6 for the array of individually controllable elements AE, so that a property of all of the elements 6 of the array of individually controllable elements AE may be determined, and, if necessary, compensated for when using the array of individually controllable elements AE to control a distribution of a radiation beam.

FIG. 3 depicts a part of the array of individually controllable elements AE. In particular, FIG. 3 shows three elements of the array of individually controllable elements: a first element 20, a second element 22, and a third element 24. Three measurement beams of radiation are also shown, which will be incident upon the elements 20, 22, 24 in sequence, and not simultaneously: a first measurement beam 26, a second measurement beam 28, and a third measurement beam 30. FIG. 3 also shows corresponding reflected measurement beams: a first reflected measurement beam 32, a second reflected measurement beam 34 and a third reflected measurement beam 36. The reflected measurement beams 32, 34, 36 are shown being detected by the detector 4 (again, not simultaneously but in sequence).

Each of the elements 20, 22, 24 is tilted at a slightly different angle with respect to one another, meaning that each of the reflected measurement beams 32, 34, 36 are directed towards different parts of the detector 4.

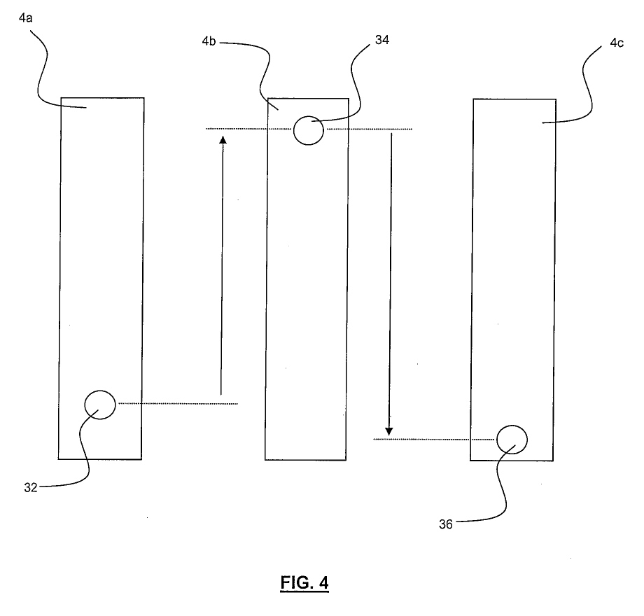

FIG. 4 schematically depicts a sequence of detection events. FIG. 4 shows the detector 4 of FIG. 3 in three states: the detector 4a when it detects the first reflected measurement beam 32, the detector 4b when it detects the second reflected measurement beam 34, and the detector 4c when it detects the third reflected measurement beam 36. A sequence of three detection events is therefore shown in FIG. 4. The three detection events correspond to measurement beams being reflected sequentially off elements of the array of individually controllable elements in the order in which the elements are located in that array.

Arrows in FIG. 4 depict the change in the position of the detected reflected measurement beam 32, 34, 36 over the sequence of detection events. The change in the detected position (i.e. the path, or in other words the route or cumulative distance) between the detected positions) is large over the sequence of events. The position changes from one end of the detector 4 to another end of the detector and then back again over the course of only three detection events. The detector 4 and associated control electronics will have an associated stabilization time which is the minimum period of time needed for the detector to stabilize after detecting the reflected measurement beam and before it is ready to detect another reflected measurement beam. As might be expected, it is desirable to reduce the time taken to determine a property of elements of the array of individually controllable elements using the described measurement apparatus. This is so that as much time as possible is available for using the array of individually controllable elements to control the distribution of a radiation beam which may be used by the lithographic apparatus to apply patterns to substrates. The more time that is available, the greater the possible throughput of the lithographic apparatus. The stabilization time of the detector and control electronics may therefore act as a restriction to the minimization of the time taken to determine a property of the elements of the array of individually controllable elements. Even if a property of the elements of the array of individually controllable elements is determined when the array of individually controllable elements AE is being used to control the distribution of a beam of radiation, the measurement of the property still serves as a restriction. It is desirable to keep measurement time as short as possible, since the measurement time determines at which rate a controller of the elements of the array receives or is provided with measurement data for each element. This, in turn, determines the control bandwidth of a control loop used to take into account the measurements and to control the elements. This, in turn, determines how well disturbances in the orientation of elements of the array can be compensated for. Finally, this, in turn, determines the accuracy of the overall compensation control loop.

As described above, FIG. 4 shows that a property of elements of the array of individually controllable elements is measured in a sequence in which the elements are located on the array of individually controllable elements. The consequence of this is that the detected change in the position of the reflected measurement beam for each respective element may change greatly, for example from one end of the detector to another in subsequent measurements (or in other words, detection events). Because of this large change, the detector and associated control electronics may take longer to stabilize between successive detections.

According to an embodiment of the present invention, a problem associated with the long stabilization time can be reduced or overcome by detecting reflected measurement radiation beams which are, in the detection sequence, known or expected to be incident on the detector in locations which are relatively adjacent to one another in that sequence. In other words, instead of determining a property of elements of the array of individually controllable elements in the sequence in which the elements are located in the array, an embodiment of the present invention is directed towards determining a property of the elements of the array in an order (or in other words sequence) which is related to the orientation (e.g. tilt, elevation, rotation, etc, and not position) of elements of the array of individually controllable elements. The orientation of the elements may be associated with, or correspond to an expected detection property, or expected measurement values of the elements, for example the positions of detected measurement radiation beams on the surface of a detector.

As described above, the array of individually controllable elements will be configured to control the distribution of a radiation beam which is incident upon it. Elements of the array of individually controllable elements will therefore be oriented to direct different parts of a radiation beam in different directions to create, for example, a desired illumination mode in that beam. The illumination mode, and therefore the orientation (for example, the degree of tilt, elevation, etc.) of the elements of the array of individually controllable elements, will be pre-determined. In a corresponding manner, the approximate or exact positions of each of the reflected measurement beams of radiation used to detect a property of the elements of the array of individually controllable elements will also be known in advance. Since these positions will be known in advance, the measurement apparatus can be controlled to ensure that measurement radiation beams are selectively and sequentially directed at different elements of the array of individually controllable elements which will result in reflected measurement beams of radiation which are incident upon the detector at locations which are adjacent to one another. This will result in a reduction in the stabilization time of the detector, and therefore a reduction in the total time necessary to determine a property of all of the elements of the array of individually controllable elements. For example, the sequence in which the elements of the array of the individually controllable elements are measured may be related to the illumination mode (e.g. pupil shape) which the array of individually controllable elements will be configured to establish in a radiation beam, which will be related to a specific set of orientations of the elements in the array.

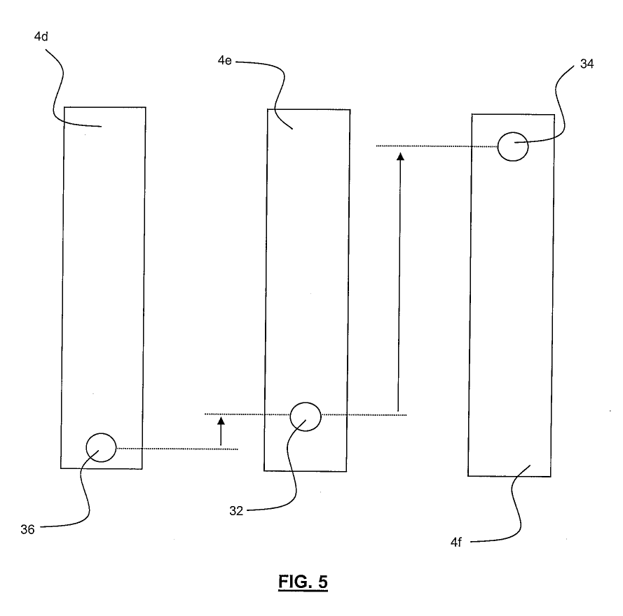

FIG. 5 schematically depicts a sequence of detection events according to an embodiment of the present invention. FIG. 5 shows that instead of detecting measurement radiation beams reflected off elements of the array of individually controllable elements in the sequence in which the elements are positioned on the array, the reflected measurement radiation beams 32, 34, 36 are detected, in sequence, with regard to their proximity to one another on the detector. Turning to FIG. 3, the first element 20, second element 22, and third element 24 are arranged in a one-dimensional array. Due to the elements 20, 22 and 24 being arranged in a one-dimensional array, the detection sequence which results in the minimum distance on the detector between successive detection events (i.e. the shortest path, or in other words the shortest route or shortest cumulative distance) will be directly related to the degree of tilt of the elements 20, 22 and 24.

Referring back to FIG. 5, the measurement beams 26, 28, 30 are generated, directed at the appropriate element, and detected as reflected measurement beams in the positional order in which the reflected measurement beams 32, 34, 36 are detected on the detector. In FIG. 5, the ‘order’ is taken to be from the bottom to the top of the detector, but could just as easily be taken to be from the top to the bottom of the detector. Thus, a first detection event 4d corresponds to the detection of the reflected measurement beam of radiation which is nearest the bottom of the detector, which in this case is the third reflected measurement beam of radiation 36. It is important to point out that the term “third” is used here to identify a particular beam of radiation, and does not in any way indicate that the beam of radiation is third in a sequence of generated beams of radiation. A second detection event 4e corresponds to the detection of the first reflected measurement beam of radiation 32, which is, in successive detection terms, the nearest detection event on the detector to the first detection event 4d. Again, the term “first” does not in any way denote an order in any sequence, but is used simply to identify a particular radiation beam. Finally in the sequence, a third detection event 4f corresponds to the detection of the second reflected measurement beam of radiation 34 which is, again, the next nearest detection event on the detector to the second detection event 4e. Again, the term “third” does not denote any order in any sequence, but instead it is used simply to distinguish one radiation beam from another radiation beam.

Arrows in FIG. 5 depict the change in the position of the detected reflected measurement beam 32, 34, 36 over the sequence of detection events. It will be appreciated that the total length of the arrows FIG. 5 is considerably shorter than the corresponding arrows shown in FIG. 4. By undertaking the measurement of a property of elements of the array of individually controllable elements in the manner described in relation to FIG. 5, the shortest possible distance on the detector between detection events is achieved. It will be appreciated from a comparison of FIGS. 4 and FIG. 5 that the stabilization times between detection events in FIG. 5 is far less than the stabilization times in relation to the detection sequences shown in and described with reference to FIG. 4. It is easier (e.g. quicker) for a detector and associated control electronics to move to and stabilize at a position which is closer to a previously detected position than it is for a position which is further away from a previous detected position. This means that a detection sequence may be undertaken more rapidly using the sequence described in relation to FIG. 5 than it would be using the sequence described in relation to FIG. 4.

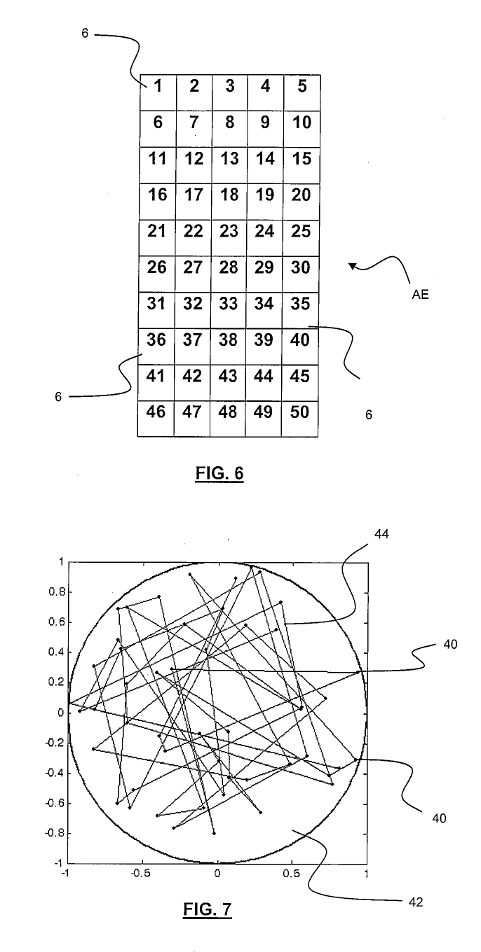

FIGS. 3 to 5 have been used to describe an embodiment of the present invention in relation to a one-dimensional array of individually controllable elements. In a practical lithographic apparatus, the use of one or more two-dimensional arrays of individually controllable elements is commonly used in, for example, an illuminator. FIG. 6 schematically depicts a two-dimensional array of individually controllable elements AE. FIG. 6 depicts an array comprising five columns of elements 6, each column comprising ten rows of elements 6. In total, therefore, the array of individually controllable elements AE comprises fifty elements 6. In practice, an array of individually controllable elements used in an illuminator of a lithographic apparatus may comprise many more elements, for example 4000 or more. However, a reduced number of fifty elements in a two-dimensional array is useful for illustrating further principles associated with an embodiment of the invention.

FIG. 7 is a schematic representation of where radiation beams reflected by tilted elements of the array of individually controllable elements shown in FIG. 6 might be expected to be located. The locations can be visualized in one of a number of ways. For example, the location may be explained in terms of a position in a pupil plane of the radiation beam whose distribution is being controlled by the array of individually controllable elements AE, or by positions on the detector of the measurement apparatus used to determine a property of the elements of the array in sequence. Whichever way FIG. 7 is interpreted, points 40 in FIG. 7 correspond to the positions of reflected radiation beams, or portions of a radiation beam, in a plane 42. Lines 44 joining up the points 40 are representative of the order in which the position of each of the points 40 is detected. In particular, the order shown in FIG. 7 relates to each of the elements 6 (as shown in FIG. 6) being probed with a radiation beam, and a reflected radiation beam being detected, in the order in which the elements appear in the array of individually controllable elements AE. In that sense, the lines 44 of FIG. 7 are similar to the arrows shown in and described with reference to FIGS. 4 and 5.

FIG. 7 appears to show that the lines 44 that join the points 40 appear to have no particular order. Furthermore, it can be seen that lines 44 only link adjacent points 40 on rare occasions. This is because the order in which the measurement apparatus is used to generate and detect measurement beams of radiation is not controlled to take into account the position of the reflected beams of radiation on the detector (or in the pupil plane, or more generically the orientation of the elements in the array), but is instead only configured to take into account the order of the elements in which they are located in the array. Therefore, FIG. 7 schematically depicts in two-dimensions a same problem as shown in and described with reference to the one-dimensional arrangement shown in and described with reference to FIG. 4. In summary, by controlling the measurement apparatus to generate and detect measurement radiation beams directed at elements of the array in the sequence in which the elements appear in the array, stabilization times of the detector and associated control electronics are long. Desirably these stabilization times should be reduced.

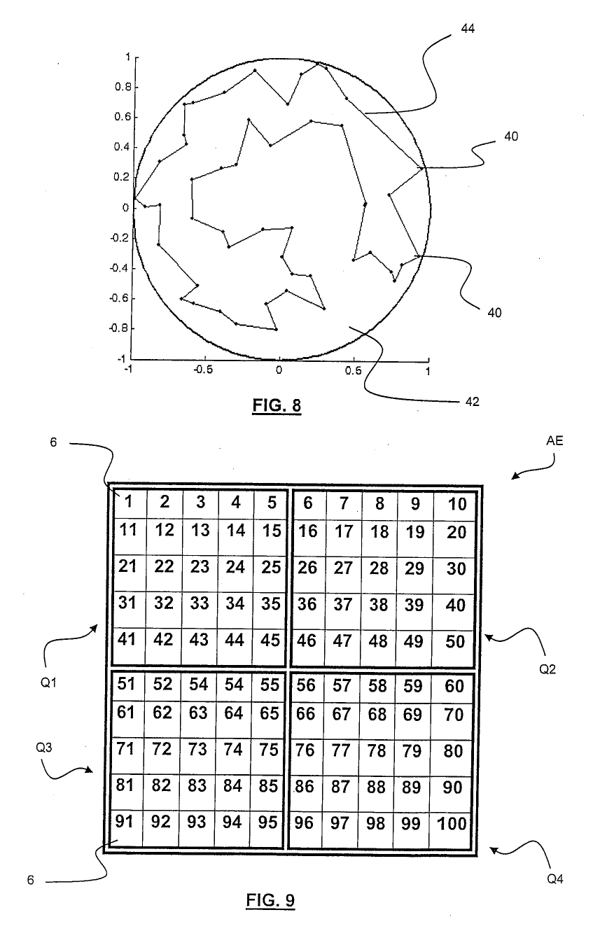

In accordance with an embodiment of the present invention, a reduction of the stabilization times, and thus a decrease in the time taken to determine a property of each of all of the elements of the array of individual controllable elements, can be achieved in much the same way as shown in and described with reference to the one-dimensional arrangement of FIG. 5. FIG. 8 shows the same distribution of points 40 that is shown in and described with reference to FIG. 7. Similarly, the lines 44 connecting the points 40 again represent the order in which the measurement apparatus is controlled to generate and detect measurement radiation beams reflected off elements of the array of individual controllable elements. However, in stark contrast with the situation schematically depicted in FIG. 7, FIG. 8 schematically depicts the situation where the lines 44 are connected to adjacent points 40 such that the shortest change between points 40 (i.e. the shortest path, or in other words the shortest route or shortest cumulative distance) is achieved. In terms of the generation and detection of measurement beams of radiation, this means that the measurement apparatus is not controlled to detect and generate measurement radiation beams which are directed at elements of the array of individually controllable elements in the order in which they appear in the array, but is instead controlled to generate and detect measurement beams of radiation in relation to the orientation of the elements of the array. This means that instead of considering the position of the elements in the array of individually controllable elements, the position of beams of radiation reflected by the elements in a plane (for example, a pupil plane or a surface of the detector) is taken into consideration. It can be seen from a comparison between FIG. 8 and FIG. 7 that the total distance traveled between the points 40 (i.e. the path, or in other words the route or cumulative distance) defined by the total length of the lines 44 is far greater in FIG. 7 than it is in FIG. 8. Thus, the associated stabilization time, and therefore detection time in total, for the detection sequence described in FIG. 7 is also far greater than the detection sequence described in relation to FIG. 8.

When comparing the average distance between points 40 linked by lines 44 in FIG. 7 and FIG. 8, the average distance between each point 40 is 4.6 times smaller for the detection sequence shown in and described with reference to FIG. 8. This reduction in distance is for an array of individually controllable elements comprising fifty elements. This saving in the average distance may increase as the number of elements in the array increases. For instance, for an array comprising four thousand individually controllable elements, the average distance between adjacent points may be thirty six times smaller when the orientation of the elements of the array are taken into account in the detection sequence. This is in comparison with a detection sequence merely corresponding to the position of the elements on the array.

FIG. 9 schematically depicts an array of individually controllable elements AE (e.g. a mirror array) provided with one hundred individually controllable elements 6. The array AE is arranged into ten columns of elements 6, each column comprising ten rows of elements 6. The array AE therefore contains one hundred elements 6. The array of individually controllable elements AE may, for example, form part of an illuminator of a lithographic apparatus, for instance the illuminator shown in and described with reference to FIG. 1. It will be appreciated that in practice, an array of individually controllable elements used in a lithographic apparatus may comprise a far greater number of elements 6 than one hundred, and may for example comprise four thousand elements or more. The depiction of a reduced number of elements in FIG. 9, and the description thereof, allows a clearer explanation of principles associated with an embodiment of the invention.

In order to actuate elements 6 of the array of individually controllable elements AE, elements 6 in the array must be addressed. For example, an electrical signal might be provided at the location of an element 6 in order to control its orientation, for example, its degree of tilt. The approximate or exact nature of a signal required to orient an element 6 to a certain degree will be known in advance. Instructions for providing that signal, or details of that signal, may be stored in for example a data array in a computer storage medium or the like.

It is not practical to use a single control apparatus to address each individual element 6 of the array AE. This is because it would take too long for a single control apparatus to individually and sequentially address each of the elements of the array in turn, especially when the number of elements in the array may exceed four thousand. Therefore, in order to speed up the addressing process and make it more efficient, a plurality of control apparatuses (sometimes referred to as drivers, or driver integrated circuits), each control apparatus being associated with and responsible for addressing a particular number of elements, is provided.

FIG. 9 shows how a plurality of control apparatus may be provided for the control and addressing of a number of different elements 6 of the array of individually controllable elements AE. It can be seen that the one hundred elements 6 of the array of individually controllable elements AE have been divided into four different areas of elements 6, each area comprising a quarter (i.e. twenty five) of the total number of elements 6 (i.e. one hundred): Q1, Q2, Q3 and Q4. The different areas Q1, Q2, Q3 and Q4 of the array of individually controllable elements AE have been marked out using a double-lined border. It will be appreciated that in practice no such physical or visual border need exist. The elements 6 of the array of individually controllable elements AE will only be “divided” in terms of the control apparatus that are or is used to address elements 6 in each of the different areas Q1, Q2, Q3 and Q4.

A control apparatus for each of the areas Q1, Q2, Q3 and Q4 of the array of individually controllable elements AE can become overloaded with data, while other control apparatus remain idle. This is particularly true when the data rates (i.e. the instructions for addressing or actuating elements of the array) are high, for example several Gigabits per second. A single control apparatus cannot process or act upon such high data rates because of the high voltage requirements associated with the control and actuation of each element of the array of the individually controllable elements. According to an embodiment of the present invention, this problem can be overcome by ensuring that consecutive actions (e.g. addressing, tilts, movements, etc) of the elements of the array should be undertaken by different control apparatus. This allows the high data rate to be shared more equally between different control apparatuses, allowing high data rates to be used to actuate large numbers of elements of an array of individually controllable elements and at a high speed.

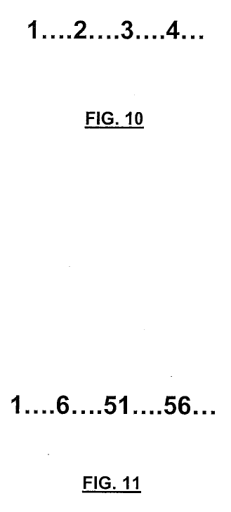

FIG. 10 schematically depicts a known order in which elements of an array of individually controllable elements may be addressed for actuation. With simultaneous reference to FIG. 9, it can be seen that the first, second, third and then fourth elements of the array are addressed and actuated in sequence. All of these elements are in an area Q1 of the array of individually controllable elements AE that is controlled (e.g. driven) by a single control apparatus. Due to the high voltage requirements necessary for actuation of each of the elements of the array of individually controllable elements, and the fast data rates that are provided to the array, using a single control apparatus to actuate the first, second, third and fourth elements may restrict the maximum speed at which these elements can be addressed.

FIG. 11 therefore shows an alternative and improved addressing scheme (or in other words, an improved control or driving scheme). FIG. 11, in combination with FIG. 9, shows that each element that is successively addressed is in an area of the array of individually controllable elements AE that is controlled by different control apparatus. Specifically, it can be seen that a first element that is addressed is element number 1, which is located in an area Q1 controlled by a first control apparatus. A second element to be addressed is element number 6 in the array, and is located in an area Q2 of the array controlled by a second control apparatus. A third element to be addressed is element number 51, which is located in a third area Q3 of the array controlled by a third control apparatus. A fourth element to be addressed is element number 56, which is located in an area Q4 of the array that is controlled by a fourth controlled apparatus. In summary, each successively (or in other words consecutively) addressed element is located in an area of the array which is controlled by a different control apparatus. This allows the elements of the array to be driven at a higher rate or speed, because none of the successively driven elements are located in an area controlled by the same single control apparatus.

If N control apparatuses are used, then each control apparatus may only be used to control an element once in every N update (or in other words control) cycles.

Since successively driven elements are located in areas of the array controlled by different control apparatus, it may be useful to provide the element with a control signal which helps ensures that any radiation reflected from the element is reflected to the same target location as it would have been if the radiation had been reflected off an element which was adjacent to a previously addressed element. In other words, the control signal may need to be changed or corrected (in comparison with prior art signals) to take into account the fact that successively addressed or driven elements may not be adjacent to one another, and may instead be located in an area of the array controlled by a different control apparatus.

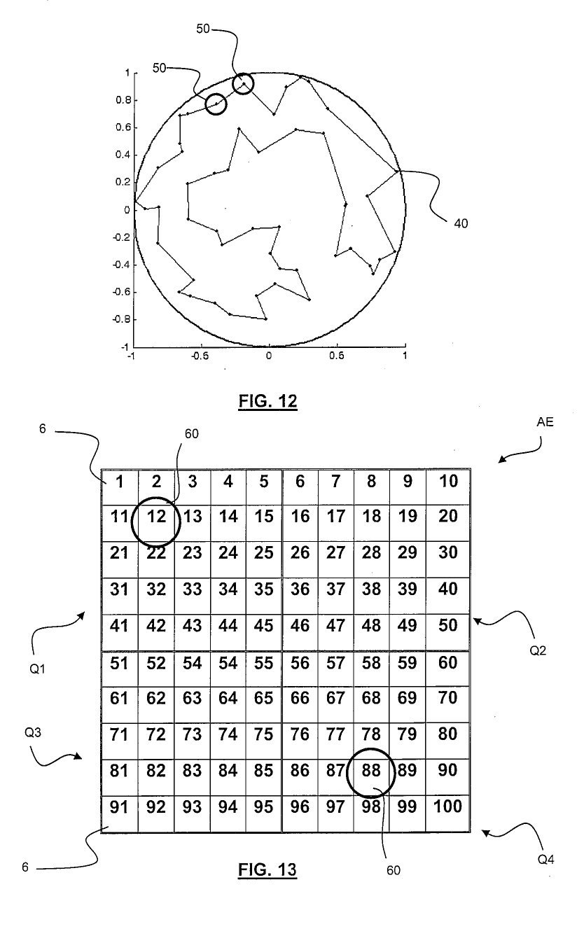

This principle of the successive addressing or driving of elements that are controlled by different control apparatus can be, for example, used in connection with the embodiments described above in relation to FIG. 3 to 8. For instance, arrays of individually controllable elements are, at least in part, controlled by an element (e.g. mirror) allocation algorithm that assigns a set point for each individual element. The set point may be a point where an element of the array should, for example, reflect a part of a radiation beam. The set point may therefore be associated with the orientation of the element, for instance its degree of tilt. The algorithm can be constructed or configured to take into account the need for each successively addressed element to be addressed by a different control apparatus. For example, parts of a reflected radiation beam that will be close to each other in a pupil plane (or on a detector) could be mapped on to elements that are driven by different control apparatus. This may help ensure that the illumination mode is established quickly. FIGS. 12 and 13 show an example of this principle.

FIG. 12 is, in general, the same as FIG. 8 described in detail above. In FIG. 12, however, two specific points 50 of the plurality of points 40 are highlighted. These two specific points 50 are highlighted because they are located adjacent to one another in the pupil plane 42, the pupil plane being described above. FIG. 13 is, in general, the same as FIG. 9 described in detail above. In FIG. 13, however, two specific elements 60 of the plurality of elements 6 of the array AE are highlighted. These specific elements 60 are used to direct beams of radiation to the specific points 50 shown in and described with reference to FIG. 12. According to an embodiment of the present invention, it can be seen that elements 60 which are located in areas Q1, Q4 of the array AE that are controlled by different control apparatus are used to direct beams of radiation to points 50 which are located adjacent to one another in, for example, a pupil plane.

The benefits of the embodiments shown in and described with reference to FIGS. 3 to 8, may be combined with the benefits of the embodiments shown in and described with reference to FIGS. 9 to 11. High data rates may be achieved by ensuring that successively addressed or controlled elements are addressed or controlled by different control apparatus, and measurement radiation beams may be generated, directed and detected in order to determine a property of these elements in an order or sequence that is related to the orientation of those elements (e.g. the degree of tilt, which in turn is related to the position of a radiation beam reflected from the elements in the pupil plane or on a surface of a detector).

In some embodiments, the sequence of measurements of a property of elements of the array of individually controllable elements, and their subsequent actuation for controlling a distribution (e.g. angular and/or intensity distribution) of a radiation beam may be identical. However, a short delay between measurement and actuation can be allowed, especially given the large number of elements for which a property will need to be measured or determined. A short delay in the measurement sequence (for example 5-10 measurements) will allow a measurement sequence that does not need to be identical to the actuation sequence. This means that, for example, measurements of a property of an element in one area of the array controlled by a first control apparatus can be undertaken and elements in another area of the array of individually controllable elements controlled by another control apparatus can be actuated to control a distribution (e.g. angular and/or intensity distribution) of a radiation beam. When the time comes for actuating the element that was measured in the first area of the array, the measurement that was undertaken previously can be used to undertake compensation in the signal that is applied to actuate the elements. The compensation in the applied signal may be, for example, to correct for a drift in the tilt of the element for a given applied voltage. The drift may be due to heating of the element, a build of charge, or degradation of the array of elements.

In the embodiments described above, a measurement of, for example, the tilt of an element is undertaken to determine if the degree of tilt has changed from an expected degree of tilt (or in other words a set point for the degree of tilt). Any compensation (or in other words correction) of the signal to be applied to the element to correct for the change in tilt can then be calculated and applied. The same process is undertaken for each element in the array of individually controllable elements. In other words, a single direct measurement is used to determine a property of a single element of the array of individually controllable elements.

For a large number of elements in an array of individually controllable elements, the measurement process can be time consuming. In some embodiments a direct measurement of a property of each individual element of the array may not be necessary. Therefore, in accordance with an embodiment of the present invention, a single direct measurement of a property of an element in an array is used to determine the property of that element and at least one adjacent element. By doing this, a locally correlated element disturbance may be determined and accounted for much more rapidly. Such a disturbance may include local mechanical vibration, environmental noise or sounds, or a temperature differential.

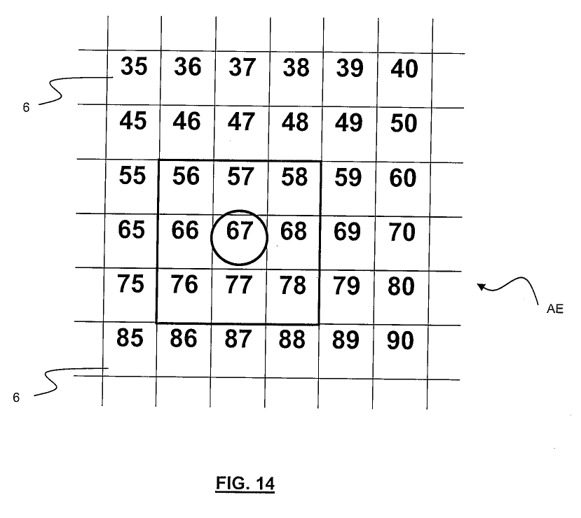

FIG. 14 shows a part of an array of individually controllable elements AE. The measurement of a property (e.g. the degree of tilt for a given control signal) of element number 67 of the AE may be used to determine a property of not only element number 67, but also one or more of the surrounding adjacent elements, typically element numbers 56, 57, 58, 66, 68, 76, 77, and 78. This means that information at least indicative of elements surrounding the element which has been directly measured (using, for example, the measurement apparatus described above) can be determined without actually directly measuring a property of those elements. In the example shown in FIG. 14, measurement of the property of a single element may be used to determine a property of nine other elements, therefore reducing the total measurement time for all elements of the array by a factor of nine.

The next element that may need to be measured directly may be element number 70, since information indicative of a property of element 68 has already been determined and information indicative of a property of element 69 would be determined from measurement of element number 70. Of course, direct measurements can be undertaken on element number 68 or element number 69 in order to confirm or determine with greater accuracy information obtained which is at least indicative of a property of elements for which no direct measurement has yet been undertaken (e.g. elements numbers 57, 58, 68, 77, or 78).

A measurement scheme could be devised where certain sets of elements of the array are measured. In a subsequent measurement process, a different set of elements of the array can be measured, so that over time correlated and uncollerated information regarding correlated and uncorrelated disturbances of elements may be obtained and, for example, accounted for in the signals that are used to control or drive the elements. For instance, in one series of measurements, a property of elements 37, 40, 67, 70 may be determined directly, determining a property at least indicative of all adjacent elements in the process. In a next set of measurements, a property of elements 38, 41, 68, 71 (not shown) may be determined directly, determining a property at least indicative of all adjacent elements in the process. Those adjacent elements will include those for which direct measurements were previously undertaken, as well as elements for which no direct measurements have yet been undertaken. This may allow any assumptions or predictions in the property of elements not directly determined to be confirmed or improved, etc.

Direct measurements of elements in an array may be used to determine a property of other elements in any one of a number of ways. For instance, a profile of direct measurements can be used to establish a profile across the array, covering those elements for which no direct measurements have been undertaken. A property of elements for which direct measurements have not been undertaken may be derived from that profile, for example from a gradient or plot of a property measured directly from elements adjacent to those elements. A property of an adjacent element for which no direct measurement has been undertaken may be determined from an extrapolation of the property of the element for which a direct measurement was undertaken, from a projection of the property of the element for which a direct measurement was undertaken, from an estimate based on the property of the element for which a direct measurement was undertaken, or from a model or simulation based on the property of the element for which a direct measurement was undertaken. The property may be, for example, a change that is required to the orientation of the element for which no direct measurement is undertaken (in other words a compensation factor or correction). For instance, if the degree of tilt of a first element is found to have varied by a certain degree, another element in the array may have its tilt varied by this same degree, even though the tilt of the second element has not been directly measured.

Elements for which direct measurements have been undertaken may be described as ‘first’ elements, or sets of first elements, and elements for which direct measurements have not been undertaken may be described as ‘second’ elements, or sets of second elements. A property of a second element may be determined from a property of a first element using a determination arrangement. The determination arrangement could be a piece of hardware forming part of one or more of the radiation emitter or radiation detector of the measurement apparatus, or the control apparatus of the array of individually controllable elements, or be in communication with the radiation emitter and/or radiation detector and/or control apparatus. The determination arrangement may be a computer, an embedded processor, a dedicated processing card for a computer, or the like.

The second elements for which a property is indirectly determined may be located adjacent to the first elements for which a property is directly determined. Alternatively, the second elements for which a property is indirectly determined may be located remote from the first elements for which a property is directly determined. For example, a direct measurement of one or more first elements may be used to determine a property for all other elements of the array. The degree to which a property can be indirectly determined for the second elements may depend on the correlation of the disturbance which causes, for example, a change in the degree of tilt from an expected or set point tilt.

In the embodiments described above, the measurement apparatus has been described as being controlled such that a property of elements of the array of individually controllable elements is determined in a sequence that is related to the orientation (e.g. degree of tilt, elevation, etc.) of the elements. This orientation is the orientation that the elements would have when the array of individually controllable elements is configured to control a distribution (e.g. angular and/or intensity distribution) of a radiation beam. Control apparatuses configured to control elements of the array have also been described as being controlled such that successively driven elements are controlled by a different control apparatus. Furthermore, the measurement apparatus has been described as being controlled such that a property of elements of the array are indirectly determined from a direct measurement of another (e.g., adjacent) element of the array. In one or more of these embodiments, in isolation or combination, such control may be undertaken using a controller. The controller could be a piece of hardware forming part of one or more of the radiation emitter or radiation detector of the measurement apparatus, or the control apparatus of the array of individually controllable elements, or be in communication with the radiation emitter and/or radiation detector and/or control apparatus.

In order to undertake such control, the controller may be arranged to receive or be provided with information indicative of the orientation of the elements, for example the degree of tilt of each element, the shape of the illumination mode in the pupil plane, the expected position of reflected measurement beams on the detector, etc. or, for example, the order in which elements of the array should be probed to determine information about each element. Alternatively or additionally, the controller may be arranged to receive or be provided with information indicative of which elements are controlled by which control apparatus. Alternatively or additionally, the controller may be arranged to receive or be provided with information indicative of which elements of the array have had, or need to have, their property measured directly or indirectly.

The controller may be a computer, an embedded processor, a dedicated processing card for a computer, or the like.

The above embodiments of the present invention have been described in relation to an array of individually controllable elements in an illuminator of a lithographic apparatus. An embodiment of the invention described herein is equally applicable to an array of individual controllable elements in other applications, for example, as a patterning device in a lithographic apparatus. An embodiment of the invention may be applied to applications other than in lithography, for example to test (either in the manufacturing stage, or in-situ in a working product) the patterning device or patterning devices of projection equipment or the like.

The above embodiments of the present invention have been described in relation to an array of individually controllable elements, the elements of that array being reflective. Other elements may form the array. For instance, the elements may be refractive, diffractive, reflective, or any other element which can re-direct at least a part of radiation that is incident upon it.

While specific embodiments of the invention have been described above, it will be appreciated that the invention may be practiced otherwise than as described. The description is not intended to limit the invention. For example, an embodiment of the invention may take the form of a computer program containing one or more sequences of machine-readable instructions describing a method as disclosed above, or a data storage medium (e.g. semiconductor memory, magnetic or optical disk) having such a computer program stored therein.

1. A method of controlling a measurement apparatus for determining a property of an individually controllable element of an array of individually controllable elements, the array of individually controllable elements being capable of controlling a distribution of a beam of radiation, the method comprising, for a sequence of a plurality of individually controllable elements:
directing a measurement beam of radiation at an individually controllable element of the plurality of individually controllable elements; and
detecting the measurement beam once it has been re-directed by the individually controllable element,
wherein the sequence in which the method is undertaken for the plurality of individually controllable elements is related to the orientation of the plurality of individually controllable elements when the plurality of individually controllable elements are oriented to control a distribution of a beam of radiation.

2. The method of claim 1, wherein the position at which the re-directed measurement beam is detected is indicative of a property of the individually controllable element.

3. The method of claim 1, wherein the sequence is related to the orientation of the plurality of individually controllable elements when the plurality of individually controllable elements are oriented to control an angular and/or intensity distribution of a beam of radiation.

4. The method of claim 3, wherein the orientation of the plurality of individually controllable elements also corresponds to a distribution of the radiation beam in an output plane.

5. The method of claim 1, wherein the orientation of the plurality of individually controllable elements also corresponds to an expected distribution of the position of detection of the measurement beams of radiation for the plurality of elements in sequence.

6. The method of claim 1, wherein the sequence is related to a distribution of different parts of the radiation beam in an output plane that is created by the radiation beam being re-directed by the plurality of individually controllable elements.

7. The method of claim 6, wherein the sequence is related to individually controllable elements which re-direct parts of the radiation beam to positions that are adjacent to one another in the output plane.

8. The method of claim 7, wherein the sequence is such that a path around the positions of the plurality of re-directed parts of the radiation beam in the output plane is the shortest.

9. The method of claim 7, wherein the parts of the radiation beam are formed by different portions of the radiation beam being re-directed by different individually controllable elements.

10. The method of claim 1, wherein the sequence is related to an expected position of detection of the measurement beams of radiation on the surface of a detector for the plurality of elements in sequence.

11. The method of claim 10, wherein the sequence is related to elements which re-direct the measurement beam of radiation to detection positions that are adjacent to one another.

12. The method of claim 11, wherein the sequence is such that a path around the detection positions is the shortest.

13. A method of controlling an array of individually controllable elements, the array of individually controllable elements being capable of controlling a distribution of a beam of radiation, the array of individually controllable elements comprising:
a first plurality of individually controllable elements controlled by a first control apparatus, and
a second plurality of individually controllable elements controlled by a second control apparatus,
the method comprising:
controlling the first control apparatus and the second control apparatus such that consecutive actuations of the individually controllable elements of the array of individually controllable elements are undertaken by a different one of the first control apparatus and second control apparatus.

14. The method of claim 13, wherein the array of individually controllable elements are arranged to re-direct different parts of the radiation beam to different positions in an output plane, the method comprising:
controlling the array of individually controllable elements such that re-directed parts of the radiation beam which are re-directed to positions which are adjacent to one another in the output plane are re-directed by elements which are controlled by a different one of the first control apparatus and second control apparatus.

15. The method of claim 13, wherein the method is undertaken for a sequence of measurements of the individually controllable elements of the array of individually controllable elements, and also for a sequence of actuations of the individually controllable elements of the array of individually controllable elements, there being a delay between the measurement and actuation of an individually controllable element.

16. A method of controlling a measurement apparatus for determining a property of individually controllable elements of an array of individually controllable elements, the array of individually controllable elements being capable of controlling a distribution of a beam of radiation, the method comprising:
directing a measurement beam of radiation at a first individually controllable element; and
detecting the measurement beam once it has been re-directed by the first individually controllable element,
wherein a property of a second individually controllable element of the array of individually controllable elements is determined from information at least indicative of the property of the first individually controllable element.

17. The method of claim 16, wherein the position at which the re-directed measurement beam is detected is indicative of a property of the first individually controllable element.

18. The method of claim 17, wherein the second individually controllable element is located adjacent to the first individually controllable element.

19. The method of claim 16, wherein the second individually controllable element is located in the array at a position that is next to a position of the first individually controllable element.

20. The method of claim 16, wherein the method is undertaken for a plurality of first individually controllable elements and a plurality of second individually controllable elements.

21. The method of claim 16, wherein the property of the second individually controllable element is determined using a property of at least two first individually controllable elements.

22. The method of claim 16, wherein the method is undertaken for a first set of first individually controllable elements and a first set of second individually controllable elements, and then the method is undertaken for a second set of first individually controllable elements and a second set of second individually controllable elements.

23. The method of claim 22, wherein the individually controllable elements of the first set of first individually controllable elements are different to the individually controllable elements of the second set of first individually controllable elements.

24. The method of claim 22, wherein the individually controllable elements of the first set of first individually controllable elements are located in positions in the array of individually controllable elements which are adjacent to the positions of the individually controllable elements of the second set of first individually controllable elements.

25. The method of claim 16, wherein the property of the second individually controllable element is determined from an extrapolation of the property of the first individually controllable element, from a projection of the property of the first individually controllable individually controllable element, from an estimate based on the property of the first individually controllable element, or from a model or simulation based on the property of the first individually controllable element.

26. The method of claim 1, wherein the method is undertaken for an array of individually controllable elements of a lithographic apparatus.

27. A measurement arrangement, comprising:
a radiation source configured to provide a measurement beam of radiation, the measurement beam of radiation being arranged to be directed at an individually controllable element of an array of individually controllable elements, the array of individually controllable elements being capable of controlling a distribution of a beam of radiation, and the individually controllable element being arranged to re-direct the measurement beam of radiation;
a detector arranged to receive the re-directed measurement beam; and
a controller configured to control the radiation source and/or the detector, the controller being configured such that, for a sequence of a plurality of individually controllable elements:
a measurement beam of radiation is arranged to be directed at an individually controllable element of the plurality of individually controllable elements, and
the measurement beam is arranged to be detected once it has been re-directed by the individually controllable element,
wherein the sequence is related to the orientation of the plurality of individually controllable elements when the plurality of individually controllable elements are oriented to control a distribution of a beam of radiation.

28. The arrangement of claim 27, wherein the detector is arranged to determine the position at which the re-directed measurement beam is incident upon the detector, the position at which the re-directed measurement beam is incident upon the detector being indicative of a property of the individually controllable element.

29. An arrangement for controlling a distribution of a beam of radiation, the arrangement comprising:
an array of individually controllable elements, the array of individually controllable elements being capable of controlling a distribution of a beam of radiation;
a first control apparatus configured to control a first plurality of individually controllable elements of the array of individually controllable elements;
a second control apparatus configured to control a second plurality of individually controllable elements of the array of individually controllable elements; and
a controller arranged to control the first control apparatus and the second control apparatus such that consecutive actuations of the individually controllable elements of the array of individually controllable elements are undertaken by a different one of the first control apparatus and second control apparatus.

30. A measurement arrangement, comprising:
a radiation source configured to provide a measurement beam of radiation, the measurement beam of radiation being arranged to be directed at a first individually controllable element of an array of individually controllable elements, the array of individually controllable elements being capable of controlling a distribution of a beam of radiation, and the individually controllable element being arranged to re-direct the measurement beam of radiation;
a detector arranged to receive the re-directed measurement beam; and
a determination arrangement configured to determine a property of a second individually controllable element from information at least indicative of the property of the first individually controllable element.

31. The measurement arrangement of claim 30, wherein the detector is configured to determine the position at which the re-directed measurement beam is incident upon the detector, the position at which the re-directed measurement beam is incident upon the detector being indicative of a property of the first individually controllable element.

32. (canceled)

33. (canceled)
